(19) United States
(12) Patent Application Publication
(10) Pub. No.: US 2026/0059479 A1
(43) Pub. Date: Feb. 26, 2026

(54) METHOD AND APPARATUS FOR WIRELESS COMMUNICATION

(71) Applicant: Bunker Hill Technologies LLC, Allen, TX (US)

(72) Inventors: Qi JIANG, Shanghai (CN); Xiaobo ZHANG, Shanghai (CN)

(21) Appl. No.: 19/105,744

(22) PCT Filed: Aug. 21, 2023
(86) PCT No.: PCT/CN2023/113984

§ 371 Date: Feb. 21, 2025

(30) Foreign Application Priority Data
Aug. 30, 2022 (CN) 202211046041.5

(51) Int. Cl. H04W 64/00; H04L 5/00; H04W 92/18

(52) U.S. Cl. CPC H04W 64/00; H04L 5/0048; H04W 92/18

(57) ABSTRACT

The present application discloses a method and apparatus for wireless communication. A node firstly receives a first information block set, receives a first reference signal via a sidelink, and receives a second reference signal via a downlink; and then the node sends first position information. The first information block set is used for determining the second reference signal. The reception of the first reference signal and the reception of the second reference signal are jointly used for determining the first position information. According to the present application, for positioning requirements on the sidelink, transmission of a positioning reference signal on the sidelink and a method for acquiring the position information are improved, and a positioning reference signal on a cellular link is also used for positioning on the sidelink, such that the positioning precision is improved, and the overall performance of a system is improved.

### RELATED APPLICATIONS

This application is a National Stage under 35 USC 371 of and claims priority to International Application No. PCT/CN2023/113984, filed Aug. 21, 2023, which claims the priority benefit of CN application No. 202211046041.5, filed Aug. 30, 2022.

### TECHNICAL FIELD

The present invention relates to a method and a device in a wireless communication system, and in particular to a solution and a device for positioning in a wireless communication system.

### BACKGROUND ART

Positioning is an important application in the field of wireless communications. The emergence of new applications such as V2X (Vehicle to everything) or industrial Internet of Things has put forward higher requirements for positioning accuracy or latency. In the 3GPP (3rd Generation Partner Project) RAN (Radio Access Network) #94e meeting, a research project on positioning enhancement was launched.

### SUMMARY OF THE INVENTION

According to the work plan in RP-213588, NR Rel-18 needs to support enhanced positioning technology for sidelink positioning (SL Positioning). The mainstream sidelink positioning technologies include SL RTT (Round Trip Time), SL AOA (Angle of Arrival), SL TDOA (Time Difference Of Arrival) and SL AOD (Angle of Departure), etc. The execution of these technologies depends on the measurement of SL PRS (Sidelink Positioning Reference Signal). Since the sender of SL PRS may be mobile, the traditional positioning process or location information feedback scheme needs to be further enhanced. At the same time, in Rel-16 and Rel-17 cellular systems, multiple positioning technologies and related location information (Location Information) are also introduced based on PRS. Is it possible to integrate the PRS and SL of the cellular link? The combined use of PRS for positioning is also an issue that needs to be considered.

In view of the above problems, this application discloses a solution. It should be noted that in the description of this application, only the V2X scenario is used as a typical application scenario or example; this application is also applicable to scenarios other than V2X that face similar problems, such as public safety. Safety), industrial Internet of Things, etc., and achieve technical effects similar to those in NR V2X scenarios. In addition, although the motivation of this application is for the scenario where the sender of the wireless signal used for positioning measurement is mobile, this application is still applicable to the scenario where the sender of the wireless signal used for positioning measurement is fixed, such as RSU (Road Side Unit, roadside unit), etc. The use of a unified solution for different scenarios also helps to reduce hardware complexity and cost. In the absence of conflict, the embodiments and features in any node of the present application can be applied to any other node. In the absence of conflict, the embodiments and features in the embodiments of the present application can be combined with each other at will. In particular, the interpretation of the terms (Terminology), nouns, functions, and variables in the present application (if not otherwise specified) can refer to the definitions in the 3GPP specification protocols TS36 series, TS38 series, and TS37 series. If necessary, reference can be made to 3GPP standards TS38.211, TS38.212, TS38.213, TS38.214, TS38.215, TS38.321, TS38.331, TS38.305, and TS37.355 to assist in the understanding of the present application.

The present application discloses a method in a first node for wireless communication, comprising:
receiving a first information block set, receiving a first reference signal via a sidelink, and receiving a second reference signal via a downlink;
sending first location information;
The first information block set is used to determine the second reference signal; and the reception of the first reference signal and the reception of the second reference signal are used together to determine the first position information.

As an embodiment, the above method is characterized in that both the downlink PRS and the sidelink PRS are used for positioning of the sidelink, thereby improving positioning accuracy and enhancing overall performance.

As an embodiment, the above method is characterized in that: a link is established between the downlink PRS and the sidelink PRS to ensure the positioning performance in the beamforming scenario.

According to one aspect of the present application, it is characterized by comprising:
sending a third reference signal;
The reception timing of the second reference signal is used to determine the transmission timing of the third reference signal.

As an embodiment, the above method is characterized in that: the SL sent by the first node The timing of the PRS refers to the uplink timing of the first node to ensure that no interference is caused to the uplink reception of the base station corresponding to the serving cell of the first node.

According to one aspect of the present application, it is characterized in that the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

As an embodiment, the above method is characterized in that reference signals belonging to the same reference signal resource set can be jointly detected to obtain more accurate position information.

According to one aspect of the present application, it is characterized in that the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

As an embodiment, the above method is characterized in that the transmission timings of reference signals belonging to the same reference signal resource set are all the same, thereby ensuring accuracy when applied to position information generation.

According to one aspect of the present application, it is characterized in that the meaning that the transmission timings of the K1 first-type reference signals are the same includes: the K1 first-type reference signals are transmitted using the same timing advance value.

According to one aspect of the present application, it is characterized in that a sender of the first reference signal and a sender of the second reference signal are not co-located.

According to one aspect of the present application, it is characterized in that the sender of the first reference signal includes a second node, the second node receives the second reference signal, and the time difference between the reception time of the second reference signal and the transmission time of the first reference signal is known to the first node.

According to one aspect of the present application, it is characterized in that the first information block set is used to determine whether the first reference signal and the second reference signal are associated.

The present application discloses a method in a second node for wireless communication, comprising:
Sending a first reference signal via a secondary link;
The recipient of the first reference signal includes a first node; the first node receives a first information block set and receives a second reference signal via a downlink; the first information block set is used to determine the second reference signal; the reception of the first reference signal and the reception of the second reference signal are jointly used to determine first location information; the first node sends the first location information.

According to one aspect of the present application, it is characterized by comprising:
receiving a first information block set, and receiving a second reference signal via a downlink;
The first information block set is used to determine the second reference signal.

According to one aspect of the present application, it is characterized by comprising:

First location information is received.

According to one aspect of the present application, it is characterized by comprising:
receiving a third reference signal;
The reception timing of the second reference signal is used by the first node to determine the transmission timing of the third reference signal.

According to one aspect of the present application, it is characterized in that the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

According to one aspect of the present application, it is characterized in that the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

According to one aspect of the present application, it is characterized in that the meaning that the transmission timings of the K1 first-type reference signals are the same includes: the K1 first-type reference signals are transmitted using the same timing advance value.

According to one aspect of the present application, it is characterized in that the second node and the sender of the second reference signal are not co-located.

According to one aspect of the present application, it is characterized in that the time difference between the reception time of the second reference signal and the transmission time of the first reference signal is known to the first node.

According to one aspect of the present application, it is characterized in that the first information block set is used to determine whether the first reference signal and the second reference signal are associated.

The present application discloses a method in a third node for wireless communication, comprising:
Sending a first information block set, and sending a second reference signal via a downlink;
The receiver of the second reference signal includes a first node; the first node receives the first reference signal through a sublink, and the first node sends first location information; the first information block set is used to determine the second reference signal; the reception of the first reference signal and the reception of the second reference signal are jointly used to determine the first location information.

According to one aspect of the present application, it is characterized by comprising:

First location information is received.

According to one aspect of the present application, it is characterized in that the first node sends a third reference signal; the reception timing of the second reference signal is used to determine the transmission timing of the third reference signal.

According to one aspect of the present application, it is characterized in that the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

According to one aspect of the present application, it is characterized in that the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

According to one aspect of the present application, it is characterized in that the meaning that the transmission timings of the K 1 first-type reference signals are the same includes: the K 1 first-type reference signals are transmitted using the same timing advance value.

According to one aspect of the present application, it is characterized in that the sender of the first reference signal and the third node are not co-located.

According to one aspect of the present application, it is characterized in that the sender of the first reference signal includes a second node, the second node receives the second reference signal, and the time difference between the reception time of the second reference signal and the transmission time of the first reference signal is known to the first node.

According to one aspect of the present application, it is characterized in that the first information block set is used to determine whether the first reference signal and the second reference signal are associated.

The present application discloses a first node for wireless communication, comprising:
A first receiver receives a first information block set, receives a first reference signal via a sidelink, and receives a second reference signal via a downlink;
A first transmitter sends first position information;
The first information block set is used to determine the second reference signal; and the reception of the first reference signal and the reception of the second reference signal are used together to determine the first position information.

The present application discloses a second node for wireless communication, comprising:
A second transmitter sends a first reference signal via a secondary link;
The recipient of the first reference signal includes a first node; the first node receives a first information block set and receives a second reference signal via a downlink; the first information block set is used to determine the second reference signal; the reception of the first reference signal and the reception of the second reference signal are jointly used to determine first location information; the first node sends the first location information.

The present application discloses a third node for wireless communication, comprising:
A third transmitter sends a first information block set and a second reference signal via a downlink;
The receiver of the second reference signal includes a first node; the first node receives the first reference signal through a sublink, and the first node sends first location information; the first information block set is used to determine the second reference signal; the reception of the first reference signal and the reception of the second reference signal are jointly used to determine the first location information.

As an embodiment, the benefit of the solution in the present application is: improving positioning accuracy.

As an embodiment, the benefit of the solution in the present application is to improve the utilization efficiency of the reference signal used for positioning in the system.

### BRIEF DESCRIPTION OF THE DRAWINGS

Other features, objects and advantages of the present application will become more apparent by reading the detailed description of non-limiting embodiments with reference to the following drawings:

FIG. 1 shows a processing flow chart of a first node according to an embodiment of the present application;

FIG. 2 shows a schematic diagram of a network architecture according to an embodiment of the present application;

FIG. 3 is a schematic diagram showing an embodiment of a wireless protocol architecture of a user plane and a control plane according to an embodiment of the present application;

FIG. 4 shows a schematic diagram of a first communication device and a second communication device according to an embodiment of the present application;

FIG. 5 shows a structural diagram of UE positioning according to an embodiment of the present invention;

FIG. 6 shows a flow chart of transmission between a first node, a second node and a third node according to an embodiment of the present application;

FIG. 7 shows a flow chart of transmission between a first node and a second node according to an embodiment of the present application;

FIG. 8 shows a flow chart of transmission between a second node and a third node according to an embodiment of the present application;

FIG. 9 shows a schematic diagram of a first node, a second node and a third node according to the present application;

FIG. 10 is a schematic diagram showing a first time difference according to the present application;

FIG. 11 is a schematic diagram showing a second time difference and a fourth time difference according to the present application;

FIG. 12 is a schematic diagram showing a third time difference according to the present application;

FIG. 13 is a schematic diagram showing the transmission timing of a given reference signal according to the present application;

FIG. 14 shows a structural block diagram of a processing device used in a first node according to an embodiment of the present invention;

FIG. 15 shows a structural block diagram of a processing device used in a second node according to an embodiment of the present invention;

FIG. 16 shows a structural block diagram of a processing device used in a third node according to an embodiment of the present invention.

### DETAILED DESCRIPTION

The technical solution of the present application will be further described in detail below in conjunction with the accompanying drawings. It should be noted that, in the absence of conflict, the embodiments of the present application and the features in the embodiments can be arbitrarily combined with each other.

### Example 1

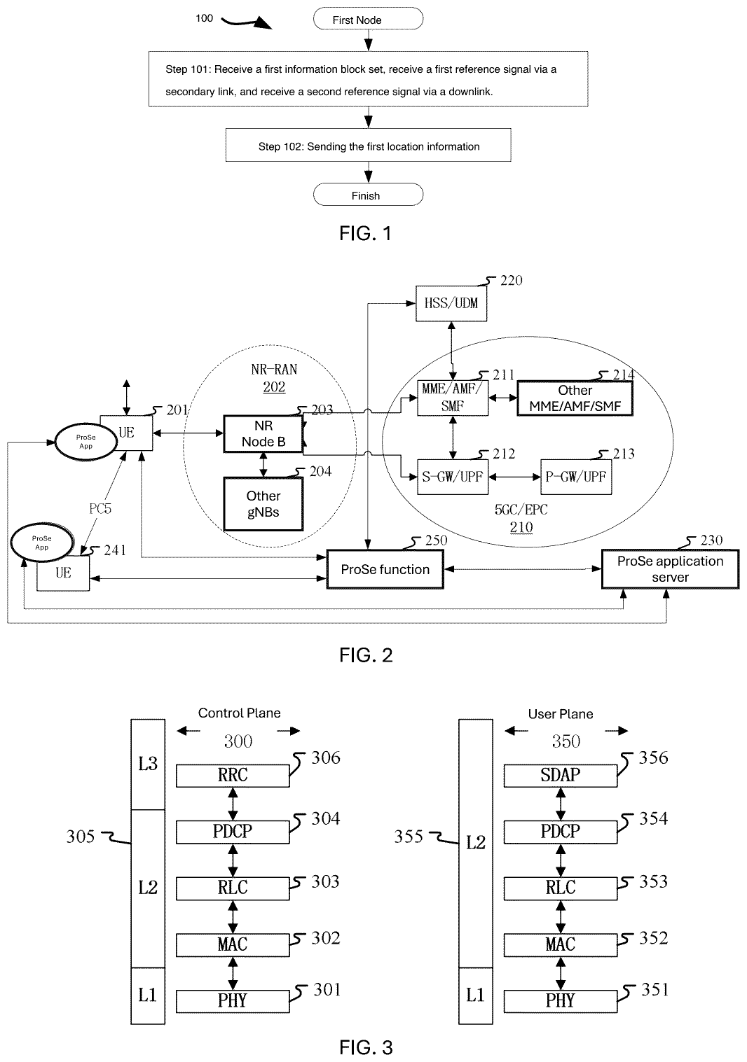

Embodiment 1 illustrates a processing flow chart of a first node, as shown in FIG. 1. In 100 shown in FIG. 1, each box represents a step. In Embodiment 1, the first node in the present application receives a first information block set in step 101, receives a first reference signal through a secondary link, and receives a second reference signal through a downlink; and sends first location information in step 102.

Embodiment 1, the first information block set is used to determine the second reference signal; and the reception of the first reference signal and the reception of the second reference signal are used together to determine the first position information.

As an embodiment, the first information block set includes RRC (Radio Resource Control) signaling.

As an embodiment, the first information block set is carried via RRC signaling.

As an embodiment, the first information block set is transmitted to the first node via LMF (Location Management Function).

As an embodiment, the name of the IE (Information Elements) carrying the first information block set includes PRS.

As an embodiment, the name of the IE carrying the first information block set includes SL.

As an embodiment, the name of the IE carrying the first information block set includes Association.

As an embodiment, the name of the IE carrying the first information block set includes Info.

As an embodiment, the name of the IE carrying the first information block set includes V2X.

As an embodiment, the name of the IE carrying the first information block set includes R18.

As an embodiment, the name of the IE carrying the first information block set includes DL.

As an embodiment, the name of the IE carrying the first information block set includes Assistance.

As an embodiment, the first information block set includes DL-PRS-ID-Info IE.

As an embodiment, the first information block set includes NR-DL-PRS-Info IE.

As an embodiment, the first information block set includes SL-PRS-ID-Info IE.

As an embodiment, the first information block set includes NR-SL-PRS-Info IE.

As an embodiment, the first information block set includes NR-DL-PRS-ResourceSet IE.

As an embodiment, the first information block set includes NR-DL-PRS-Resource IE.

As an embodiment, the first information block set includes NR-SL-PRS-ResourceSet IE.

As an embodiment, the first information block set includes NR-SL-PRS-Resource IE.

As an embodiment, the secondary link is a wireless link between terminals.

As an embodiment, the secondary link is a Sidelink.

As an embodiment, the secondary link is for a V2X link.

As an embodiment, the secondary link is for a PC5 interface.

As an embodiment, the downlink is a Downlink link.

As an embodiment, the downlink is a link sent by the base station to the terminal.

As an embodiment, the downlink is a link sent by the gNB to the terminal.

As an embodiment, the first reference signal includes a Sidelink PRS.

As an embodiment, the first reference signal includes a Sidelink SRS (Sounding Reference Signal, listen reference signal).

As an embodiment, the first reference signal includes Sidelink CSI-RS (Channel State Information Reference Signal).

As an embodiment, the first reference signal occupies one Sidelink PRS resource.

As an embodiment, the first reference signal occupies one Sidelink SRS resource.

As an embodiment, the first reference signal occupies one Sidelink CSI-RS resource.

As an embodiment, the first reference signal corresponds to a Sidelink PRS resource.

As an embodiment, the first reference signal corresponds to a Sidelink SRS resource.

As an embodiment, the first reference signal corresponds to a Sidelink CSI-RS resource.

As an embodiment, the second reference signal includes a PRS.

As an embodiment, the second reference signal includes CSI-RS.

As an embodiment, the second reference signal includes SSB (Synchronization Signal/physical broadcast channel Block).

As an embodiment, the second reference signal occupies one DL PRS resource.

As an embodiment, the second reference signal occupies one CSI-RS resource.

As an embodiment, the second reference signal occupies one SSB.

As an embodiment, the second reference signal corresponds to a DL PRS resource.

As an embodiment, the second reference signal corresponds to a CSI-RS resource.

As an embodiment, the second reference signal corresponds to an SSB.

As an embodiment, the first location information includes location information transmitted from the first node to the base station.

As an embodiment, the first location information includes location information transmitted from the first node to the base station.

As an embodiment, the first location information includes a first channel quality.

As a sub-embodiment of this embodiment, the first channel quality includes RSRP (Reference Signal Received Power) obtained by measuring the first reference signal.

As a sub-embodiment of this embodiment, the first channel quality includes RSRPP (Reference Signal Received Path Power) obtained by measuring the first reference signal.

As a sub-embodiment of this embodiment, the first channel quality includes quality (Quality) measured for the first reference signal.

As an embodiment, the first location information includes a second channel quality.

As a sub-embodiment of this embodiment, the second channel quality includes RSRP obtained by measuring the second reference signal.

As a sub-embodiment of this embodiment, the second channel quality includes an RSRPP obtained by measuring the second reference signal.

As a sub-embodiment of this embodiment, the second channel quality includes a quality measured for the second reference signal.

As an embodiment, the first location information includes a first identity set.

As a sub-embodiment of this embodiment, the first identity set includes only one identity (Identity).

As a sub-embodiment of this embodiment, the first identity set only includes multiple identities.

As a sub-embodiment of this embodiment, the first identity set includes identities corresponding to the first reference signal.

As a sub-embodiment of this embodiment, the first identity set includes the identity corresponding to the second reference signal.

As a sub-embodiment of this embodiment, the first identity set includes identities corresponding to reference signal resources occupied by the first reference signal.

As a sub-embodiment of this embodiment, the first identity set includes identities corresponding to reference signal resources occupied by the second reference signal.

As a sub-embodiment of this embodiment, the first identity set includes identities corresponding to a reference signal resource set to which the reference signal resources occupied by the first reference signal belong.

As a sub-embodiment of this embodiment, the first identity set includes identities corresponding to a reference signal resource set to which the reference signal resources occupied by the second reference signal belong.

As an embodiment, the first location information is used to indicate that the first reference signal and the second reference signal are associated.

(Quasi Co-located) relationship corresponding to the first reference signal.

As an embodiment, the first location information includes TCI-StateId corresponding to the first reference signal.

As an embodiment, the first location information includes a first time value set.

As a sub-embodiment of this embodiment, the first time value set includes only one time value.

As a sub-embodiment of this embodiment, the first time value set only includes multiple time values.

As a sub-embodiment of this embodiment, the first time value set includes a timestamp (Time Stamp) for measurement of the first reference signal.

As a sub-embodiment of this embodiment, the first set of time values includes timestamps for measurements of the second reference signal.

As a sub-embodiment of this embodiment, the first time value set includes a TA (Timing Advance) offset adopted by the first node.

As a sub-embodiment of this embodiment, the first time value set includes a first time difference, and the first time difference is the time difference between the time when the first node receives the first reference signal and the time when the first node receives the second reference signal.

As a sub-embodiment of this embodiment, the first time value set includes a second time difference, and the second time difference is the time difference between the time when the first node receives the first reference signal and the time when it sends the third reference signal.

As an embodiment, the first location information includes an AoD obtained by measuring the first reference signal.

As an embodiment, the first location information includes an AoD obtained by measuring the second reference signal.

As an embodiment, the first information block set is used to indicate the second reference signal.

As an embodiment, the first information block set is used to determine the reference signal resources occupied by the second reference signal.

As an embodiment, the first information block set is used to indicate reference signal resources occupied by the second reference signal.

As an embodiment, the first information block set is used to indicate a PRS resource, and the PRS resource includes a reference signal resource occupied by the second reference signal.

As an embodiment, the first information block set is used to indicate a PRS resource set, and the PRS resource set includes reference signal resources occupied by the second reference signal.

Typically, the first set of information blocks is used to determine whether the first reference signal and the second reference signal are associated.

As an embodiment, the phrase “the first information block set is used to determine that the first reference signal and the second reference signal are associated” means that: the first information block set is used to indicate that the first reference signal and the second reference signal are associated.

As an embodiment, the above phrase “the first information block set is used to determine that the first reference signal and the second reference signal are associated” means that: the first information block set includes configuration information of the first reference signal, and the configuration information of the first reference signal includes the identity of the second reference signal.

As an embodiment, the above phrase “the first information block set is used to determine that the first reference signal and the second reference signal are associated” means that: the first information block set includes configuration information of the second reference signal, and the configuration information of the second reference signal includes the identity of the first reference signal.

As an embodiment, the phrase that the first information block set is used to determine that the first reference signal and the second reference signal are associated includes: the first information block set is used to indicate that the first reference signal and the second reference signal are associated to the same identity.

As an embodiment, the above phrase that the first information block set is used to determine that the first reference signal and the second reference signal are associated includes: the first information block set is used to indicate that the first reference signal and the second reference signal are associated to the same QCL relationship.

As a sub-embodiment of this embodiment, the QCL relationship includes TCI-StateId.

As an embodiment, the above phrase that the reception of the first reference signal and the reception of the second reference signal are jointly used to determine the first location information includes: the first location information includes a first time difference, and the first time difference is the time difference between the time when the first node receives the first reference signal and the time when it receives the second reference signal.

As an embodiment, the above phrase that the reception of the first reference signal and the reception of the second reference signal are jointly used to determine the first position information means that the first position information includes a second time difference, the second time difference is the time difference between the time when the first node receives the first reference signal and the time when it sends the third reference signal, and the reception timing of the second reference signal is used to determine the sending timing of the third reference signal.

As an embodiment, the reception timing of the signal in the present application includes the boundary of the time slot occupied by the signal determined when the signal is received.

As an embodiment, the reception timing of the signal in the present application includes the boundary of the subframe occupied by the signal determined when the signal is received.

As an embodiment, the reception timing of the signal in the present application includes the boundary of the frame occupied by the signal determined when the signal is received.

As an embodiment, the reception timing of the signal in the present application includes the time slot timing for receiving the signal.

As an embodiment, the reception timing of the signal in the present application includes the subframe timing of receiving the signal.

As an embodiment, the reception timing of the signal in the present application includes the frame timing of receiving the signal.

As an embodiment, the transmission timing of the signal in the present application includes the boundary of the time slot occupied by the signal determined when the signal is transmitted.

As an embodiment, the transmission timing of the signal in the present application includes the boundary of the subframe occupied by the signal determined when the signal is transmitted.

As an embodiment, the sending timing of the signal in the present application includes the boundary of the frame occupied by the signal determined when the signal is sent.

As an embodiment, the sending timing of the signal in the present application includes the time slot timing for sending the signal.

As an embodiment, the sending timing of the signal in the present application includes the subframe timing of sending the signal.

As an embodiment, the sending timing of the signal in the present application includes the frame timing of sending the signal.

Typically, the first reference signal is transmitted by a second node, and the second node receives the second reference signal, and the reception of the second reference signal is used to determine the transmission timing of the first reference signal.

### Example 2

Embodiment 2 illustrates a schematic diagram of a network architecture according to an embodiment of the present application, as shown in FIG. 2. FIG. 2 illustrates a V2X communication architecture in a 5G NR (New Radio), LTE (Long-Term Evolution) and LTE-A (Long-Term Evolution Advanced) system architecture. The 5G NR or LTE network architecture may be referred to as 5GS (5G System)/EPS (Evolved Packet System) or some other appropriate terminology.

The V2X communication architecture of embodiment 2 includes UE (User Equipment) 201, UE 241, NG-RAN (next generation radio access network) 202, 5GC (5G Core Network)/EPC (Evolved Packet Core) 210, HSS (Home Subscriber Server)/UDM (Unified Data Management) 220, ProSe function 250 and ProSe application server 230. The V2X communication architecture can be interconnected with other access networks, but these entities/interfaces are not shown for simplicity. As shown, the V2X communication architecture provides packet switching services, but technicians in the field will easily understand that the various concepts presented throughout this application can be extended to networks that provide circuit switching services or other cellular networks. NG-RAN includes NR Node B (gNB) 203 and other gNBs 204. gNB 203 provides user and control plane protocol termination towards UE 201. gNB203 can be connected to other gNB204 via an Xn interface (e.g., backhaul). gNB203 may also be referred to as a base station, a base transceiver station, a radio base station, a radio transceiver, a transceiver function, a basic service set (BSS), an extended service set (ESS), a TRP (transmit receive node), or some other suitable term. gNB203 provides an access point to 5GC/EPC210 for UE201. Examples of UE201 include cellular phones, smart phones, session initiation protocol (SIP) phones, laptops, personal digital assistants (PDAs), satellite radios, non-terrestrial base station communications, satellite mobile communications, global positioning systems, multimedia devices, video devices, digital audio players (e.g., MP3 players), cameras, game consoles, drones, aircraft, narrowband Internet of Things devices, machine type communication devices, land vehicles, cars, wearable devices, or any other similar functional devices. A person skilled in the art may also refer to UE201 as a mobile station, a subscriber station, a mobile unit, a subscriber unit, a wireless unit, a remote unit, a mobile device, a wireless device, a wireless communication device, a remote device, a mobile subscriber station, an access terminal, a mobile terminal, a wireless terminal, a remote terminal, a handset, a user agent, a mobile client, a client, or some other suitable term. The gNB203 is connected to the 5GC/EPC210 via an S1/NG interface. The 5GC/EPC210 includes an MME (Mobility Management Entity)/AMF (Authentication Management Field)/SMF (Session Management Function) 211, other MME/AMF/SMF214, an S-GW (Service Gateway)/UPF (User Plane Function) 212, and a P-GW (Packet Data Network Gateway)/UPF213. MME/AMF/SMF211 is the control node that handles the signaling between UE201 and 5GC/EPC210. In general, MME/AMF/SMF211 provides bearer and connection management. All user IP (Internet Protocal) packets are transmitted through S-GW/UPF212, which itself is connected to P-GW/UPF213. P-GW provides UE IP address allocation and other functions. P-GW/UPF213 is connected to Internet services 230. Internet services 230 include operator-corresponding Internet protocol services, which may specifically include Internet, intranet, IMS (IP Multimedia Subsystem) and packet switching streaming services. The ProSe function 250 is a logical function for network-related behaviors required for ProSe (Proximity-based Service), including DPF (Direct Provisioning Function), Direct Discovery Name Management Function, EPC-level Discovery ProSe Function, etc. The ProSe application server 230 has functions such as storing EPC ProSe user identities, mapping between application layer user identities and EPC ProSe user identities, and allocating ProSe restricted code suffix pools.

As an embodiment, the UE 201 and the UE 241 are connected via a PC5 reference point (Reference Point).

As an embodiment, the ProSe function 250 is connected to the UE 201 and the UE 241 via a PC3 reference point respectively.

As an embodiment, the ProSe function 250 is connected to the ProSe application server 230 via a PC2 reference point.

As an embodiment, the ProSe application server 230 is connected to the ProSe application of the UE 201 and the ProSe application of the UE 241 through a PC1 reference point respectively.

As an embodiment, the first node in the present application is the UE201, and the second node in the present application is the UE241.

As an embodiment, the first node in the present application is the UE241, and the second node in the present application is the UE201.

As an embodiment, the wireless link between the UE201 and the UE241 corresponds to the side link (Sidelink, SL) in this application.

As an embodiment, the gNB203 corresponds to the third node in this application.

As an embodiment, the ProSe function 250 corresponds to the third node in the present application.

As an embodiment, the ProSe application server 230 corresponds to the third node in this application.

As an embodiment, the third node includes a location service center.

As an embodiment, the third node includes a base station.

In an embodiment, the location service center is a NAS (Non-Access-Stratum) device.

As an embodiment, the location service center includes LMF.

As an embodiment, the wireless link from the UE201 to the NR Node B is an uplink.

As an embodiment, the wireless link from the NR Node B to UE201 is a downlink.

As an embodiment, the UE 201 supports V2X transmission.

As an embodiment, the UE241 supports V2X transmission.

As an embodiment, the NR Node B 203 is a macro cellular (MarcoCellular) base station.

As an embodiment, the NR Node B 203 is a micro cell base station.

As an embodiment, the NR Node B 203 is a picocell base station.

As an embodiment, the NR Node B 203 is a home base station (Femtocell).

As an embodiment, the NR Node B 203 is a base station device that supports large delay difference.

As an embodiment, the NR Node B 203 is a RSU (Road Side Unit, roadside unit).

As an embodiment, the NR Node B 203 includes satellite equipment.

### Example 3

Embodiment 3 shows a schematic diagram of an embodiment of a wireless protocol architecture of a user plane and a control plane according to the present application, as shown in FIG. 3. FIG. 3 is a schematic diagram illustrating an embodiment of a radio protocol architecture for a user plane 350 and a control plane 300, and FIG. 3 shows a radio protocol architecture of a control plane 300 between a first communication node device (UE, gNB, or RSU in V2X) and a second communication node device (gNB, UE, or RSU in V2X) using three layers: layer 1, layer 2, and layer 3. Layer 1 (L1 layer) is the lowest layer and implements various PHY (physical layer) signal processing functions. The L1 layer will be referred to as PHY 301 herein. Layer 2 (L2 layer) 305 is above PHY 301 and is responsible for the link between the first communication node device and the second communication node device through PHY 301. The L2 layer 305 includes a MAC (Medium Access Control) sublayer 302, an RLC (Radio Link Control) sublayer 303, and a PDCP (Packet Data Convergence Protocol) sublayer 304, which terminate at the second communication node device. The PDCP sublayer 304 provides multiplexing between different radio bearers and logical channels. The PDCP sublayer 304 also provides security by encrypting data packets, and the PDCP sublayer 304 also provides support for inter-zone mobility of the first communication node device to the second communication node device. The RLC sublayer 303 provides segmentation and reassembly of upper layer data packets, retransmission of lost data packets, and reordering of data packets to compensate for out-of-order reception due to HARQ. The MAC sublayer 302 provides multiplexing between logical and transport channels. The MAC sublayer 302 is also responsible for allocating various radio resources (e.g., resource blocks) in a cell between the first communication node devices. The MAC sublayer 302 is also responsible for HARQ operations. The RRC (Radio Resource Control) sublayer 306 in layer 3 (L3 layer) in the control plane 300 is responsible for obtaining radio resources (i.e., radio bearers) and configuring the lower layer using RRC signaling between the second communication node device and the first communication node device. The radio protocol architecture of the user plane 350 includes layer 1 (L1 layer) and layer 2 (L2 layer). The radio protocol architecture for the first communication node device and the second communication node device in the user plane 350 is substantially the same as the corresponding layers and sublayers in the control plane 300 for the physical layer 351, the PDCP sublayer 354 in the L2 layer 355, the RLC sublayer 353 in the L2 layer 355, and the MAC sublayer 352 in the L2 layer 355, but the PDCP sublayer 354 also provides header compression for upper layer data packets to reduce radio transmission overhead. The L2 layer 355 in the user plane 350 also includes a SDAP (Service Data Adaptation Protocol) sublayer 356, which is responsible for mapping between QoS flows and data radio bearers (DRBs) to support the diversity of services. Although not shown, the first communication node device may have several upper layers above the L2 layer 355, including a network layer (e.g., an IP layer) terminated at the P-GW on the network side and an application layer terminated at the other end of the connection (e.g., a remote UE, a server, etc.).

As an embodiment, the wireless protocol architecture in FIG. 3 is applicable to the first node in the present application.

As an embodiment, the wireless protocol architecture in FIG. 3 is applicable to the second node in the present application.

As an embodiment, the PDCP 304 of the second communication node device is used to generate the scheduling of the first communication node device.

As an embodiment, the PDCP 354 of the second communication node device is used to generate the scheduling of the first communication node device.

As an embodiment, the first information block set is generated in the RRC306.

As an embodiment, the first information block set is generated on the RRC306.

As an embodiment, the first information block set is generated at the NAS layer.

As an embodiment, the first reference signal is generated by the PHY301 or the PHY351.

As an embodiment, the second reference signal is generated by the PHY301 or the PHY351.

As an embodiment, the third reference signal is generated by the PHY301 or the PHY351.

As an embodiment, the measurement of the first reference signal in the present application includes layer 3 filtering performed in the RRC sublayer 306.

As an embodiment, the measurement of the first reference signal in the present application is performed in the PHY 301 or the PHY 351.

As an embodiment, the measurement of the second reference signal in the present application includes layer 3 filtering performed in the RRC sublayer 306.

As an embodiment, the measurement of the second reference signal in the present application is performed in the PHY 301 or the PHY 351.

As an embodiment, the measurement of the third reference signal in the present application includes layer 3 filtering performed in the RRC sublayer 306.

As an embodiment, the measurement of the third reference signal in the present application is performed in the PHY 301 or the PHY 351.

As an embodiment, the first location information is generated in the RRC306.

As an embodiment, the first location information is generated at the NAS layer.

As an embodiment, the first node is a terminal.

As an embodiment, the first node is a relay.

As an embodiment, the first node is a vehicle.

As an embodiment, the second node is a terminal.

As an embodiment, the second node is a relay.

As an embodiment, the second node is a vehicle.

As an embodiment, the third node is a gNB.

As an embodiment, the third node is a TRP (Transmitter Receiver Point).

As an embodiment, the third node is used to manage multiple TRPs.

As an embodiment, the third node is a node for managing multiple cells.

As an embodiment, the third node is a node for managing multiple service cells.

As an embodiment, the third node is LMF.

As an embodiment, the third node is a location service center.

As an embodiment, the third node corresponds to the network device in this application.

### Example 4

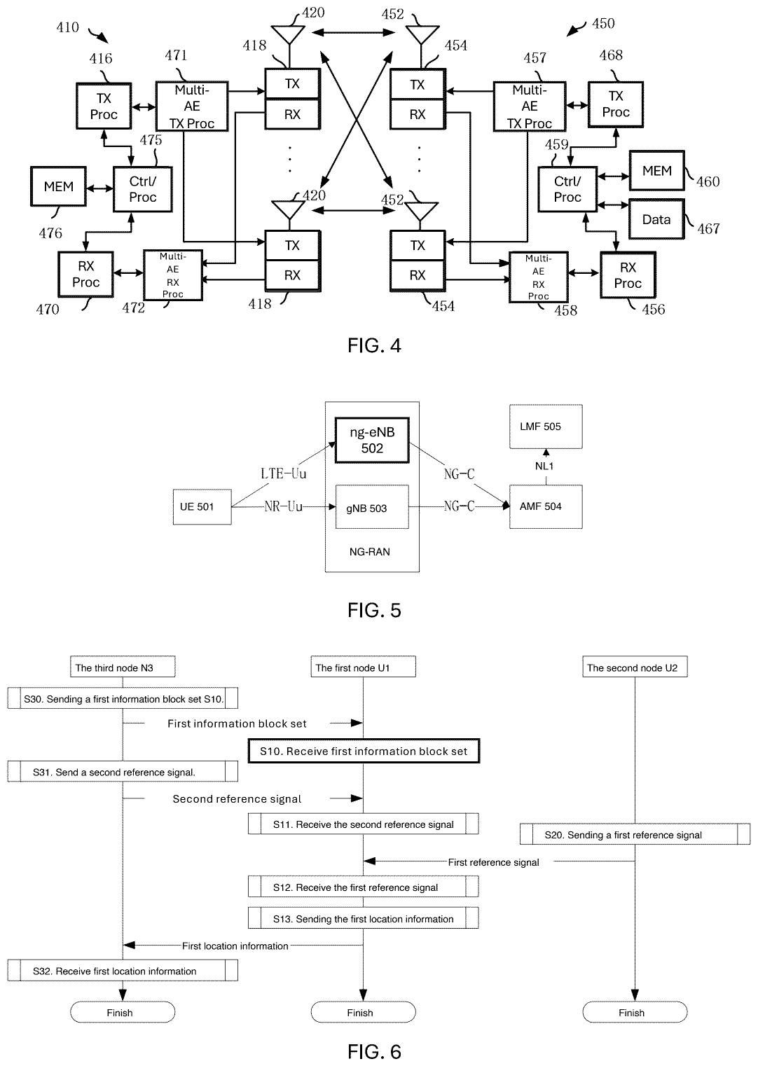

Embodiment 4 shows a schematic diagram of a first communication device and a second communication device according to the present application, as shown in FIG. 4. FIG. 4 is a block diagram of a first communication device 450 and a second communication device 410 communicating with each other in an access network.

The first communication device 450 includes a controller/processor 459, a memory 460, a data source 467, a transmit processor 468, a receive processor 456, a multi-antenna transmit processor 457, a multi-antenna receive processor 458, a transmitter/receiver 454 and an antenna 452.

The second communication device 410 includes a controller/processor 475, a memory 476, a receive processor 470, a transmit processor 416, a multi-antenna receive processor 472, a multi-antenna transmit processor 471, a transmitter/receiver 418 and an antenna 420.

In transmission from the second communication device 410 to the first communication device 450, at the second communication device 410, upper layer data packets from the core network are provided to the controller/processor 475. The controller/processor 475 implements the functionality of the L2 layer. In transmission from the second communication device 410 to the first communication device 450, the controller/processor 475 provides header compression, encryption, packet segmentation and reordering, multiplexing between logical and transport channels, and radio resource allocation to the first communication device 450 based on various priority metrics. The controller/processor 475 is also responsible for retransmission of lost packets and signaling to the first communication device 450. The transmit processor 416 and the multi-antenna transmit processor 471 implement various signal processing functions for the L1 layer (i.e., the physical layer). The transmit processor 416 implements coding and interleaving to facilitate forward error correction (FEC) at the second communication device 410, as well as mapping of signal constellations based on various modulation schemes (e.g., binary phase shift keying (BPSK), quadrature phase shift keying (QPSK), M-phase shift keying (M-PSK), M-quadrature amplitude modulation (M-QAM)). The multi-antenna transmit processor 471 performs digital spatial precoding, including codebook-based precoding and non-codebook-based precoding, and beamforming processing on the coded and modulated symbols to generate one or more spatial streams. The transmit processor 416 then maps each spatial stream to a subcarrier, multiplexes it with a reference signal (e.g., a pilot) in the time domain and/or frequency domain, and then uses an inverse fast Fourier transform (IFFT) to generate a physical channel carrying a time-domain multi-carrier symbol stream. The multi-antenna transmit processor 471 then performs a transmit analog precoding/beamforming operation on the time-domain multi-carrier symbol stream. Each transmitter 418 converts the baseband multi-carrier symbol stream provided by the multi-antenna transmit processor 471 into a radio frequency stream, and then provides it to a different antenna 420.

In the transmission from the second communication device 410 to the first communication device 450, at the first communication device 450, each receiver 454 receives a signal through its corresponding antenna 452. Each receiver 454 recovers the information modulated onto the RF carrier and converts the RF stream into a baseband multi-carrier symbol stream and provides it to the receiving processor 456. The receiving processor 456 and the multi-antenna receiving processor 458 implement various signal processing functions of the L1 layer. The multi-antenna receiving processor 458 performs a receiving analog precoding/beamforming operation on the baseband multi-carrier symbol stream from the receiver 454. The receiving processor 456 uses a fast Fourier transform (FFT) to convert the baseband multi-carrier symbol stream after the receiving analog precoding/beamforming operation from the time domain to the frequency domain. In the frequency domain, the physical layer data signal and the reference signal are demultiplexed by the receiving processor 456, wherein the reference signal will be used for channel estimation, and the data signal is recovered after multi-antenna detection in the multi-antenna receiving processor 458 to any spatial stream with the first communication device 450 as the destination. The symbols on each spatial stream are demodulated and recovered in the receive processor 456, and soft decisions are generated. The receive processor 456 then decodes and deinterleaves the soft decisions to recover the upper layer data and control signals transmitted by the second communication device 410 on the physical channel. The upper layer data and control signals are then provided to the controller/processor 459. The controller/processor 459 implements the functions of the L2 layer. The controller/processor 459 may be associated with a memory 460 that stores program codes and data. The memory 460 may be referred to as a computer-readable medium. In the transmission from the second communication device 410 to the second communication device 450, the controller/processor 459 provides multiplexing between transport and logical channels, packet reassembly, decryption, header decompression, control signal processing to recover the upper layer data packets from the core network. The upper layer data packets are then provided to all protocol layers above the L2 layer. Various control signals may also be provided to the L3 for L3 processing.

In the transmission from the first communication device 450 to the second communication device 410, at the first communication device 450, a data source 467 is used to provide upper layer data packets to the controller/processor 459. The data source 467 represents all protocol layers above the L2 layer. Similar to the transmission function at the second communication device 410 described in the transmission from the second communication device 410 to the first communication device 450, the controller/processor 459 implements header compression, encryption, packet segmentation and reordering, and multiplexing between logical and transport channels based on radio resource allocation, and implements L2 layer functions for user plane and control plane. The controller/processor 459 is also responsible for the retransmission of lost packets and signaling to the second communication device 410. The transmit processor 468 performs modulation mapping and channel coding processing, and the multi-antenna transmit processor 457 performs digital multi-antenna spatial precoding, including codebook-based precoding and non-codebook-based precoding, and beamforming processing. Then, the transmit processor 468 modulates the generated spatial stream into a multi-carrier/single-carrier symbol stream, which is then provided to different antennas 452 via the transmitter 454 after analog precoding/beamforming operations in the multi-antenna transmit processor 457. Each transmitter 454 first converts the baseband symbol stream provided by the multi-antenna transmit processor 457 into a radio frequency symbol stream, and then provides it to the antenna 452.

In the transmission from the first communication device 450 to the second communication device 410, the functions at the second communication device 410 are similar to the reception functions at the first communication device 450 described in the transmission from the second communication device 410 to the first communication device 450. Each receiver 418 receives a radio frequency signal through its corresponding antenna 420, converts the received radio frequency signal into a baseband signal, and provides the baseband signal to the multi-antenna reception processor 472 and the reception processor 470. The reception processor 470 and the multi-antenna reception processor 472 jointly implement the functions of the L1 layer. The controller/processor 475 implements the L2 layer functions. The controller/processor 475 can be associated with a memory 476 that stores program codes and data. The memory 476 can be referred to as a computer-readable medium. In the transmission from the first communication device 450 to the second communication device 410, the controller/processor 475 provides demultiplexing between transport and logical channels, packet reassembly, decryption, header decompression, control signal processing to recover the upper layer data packets from the UE 450. Upper layer packets from the controller/processor 475 may be provided to the core network.

As an embodiment, the first communication device 450 apparatus includes: at least one processor and at least one memory, the at least one memory including computer program code; the at least one memory and the computer program code are configured to be used together with the at least one processor, and the first communication device 450 apparatus at least: first receives a first information block set; then receives a first reference signal through a side link, and receives a second reference signal through a downlink; and sends first position information; the first information block set is used to determine the second reference signal; the reception of the first reference signal and the reception of the second reference signal are jointly used to determine the first position information.

As an embodiment, the first communication device 450 includes: a memory storing a computer-readable instruction program, which generates actions when executed by at least one processor, and the actions include: first receiving a first information block set; then receiving a first reference signal through a sublink, and receiving a second reference signal through a downlink; and sending first position information; the first information block set is used to determine the second reference signal; the reception of the first reference signal and the reception of the second reference signal are jointly used to determine the first position information.

As an embodiment, the second communication device 410 device includes: at least one processor and at least one memory, the at least one memory includes computer program code; the at least one memory and the computer program code are configured to be used together with the at least one processor. The second communication device 410 device at least: sends a first reference signal through a side link; the recipient of the first reference signal includes a first node; the first node receives a first information block set and receives a second reference signal through a downlink; the first information block set is used to determine the second reference signal; the reception of the first reference signal and the reception of the second reference signal are jointly used to determine the first location information; the first node sends the first location information.

As an embodiment, the second communication device 410 apparatus includes: a memory storing a computer-readable instruction program, wherein the computer-readable instruction program generates actions when executed by at least one processor, and the actions include: sending a first reference signal through a side link; the recipient of the first reference signal includes a first node; the first node receives a first information block set and receives a second reference signal through a downlink; the first information block set is used to determine the second reference signal; the reception of the first reference signal and the reception of the second reference signal are jointly used to determine first position information; the first node sends the first position information.

As an embodiment, the second communication device 410 device includes: at least one processor and at least one memory, the at least one memory includes computer program code; the at least one memory and the computer program code are configured to be used together with the at least one processor. The second communication device 410 device at least: sends a first information block set and sends a second reference signal through a downlink; the recipient of the second reference signal includes a first node; the first node receives the first reference signal through a side link, and the first node sends first location information; the first information block set is used to determine the second reference signal; the reception of the first reference signal and the reception of the second reference signal are used together to determine the first location information.

As an embodiment, the second communication device 410 apparatus includes: a memory storing a computer-readable instruction program, wherein the computer-readable instruction program generates actions when executed by at least one processor, and the actions include: sending a first information block set and sending a second reference signal via a downlink; the recipient of the second reference signal includes a first node; the first node receives the first reference signal via a side link, and the first node sends first location information; the first information block set is used to determine the second reference signal; the reception of the first reference signal and the reception of the second reference signal are jointly used to determine the first location information.

As an embodiment, the first communication device 450 corresponds to the first node in this application.

As an embodiment, the second communication device 410 corresponds to the first node in this application.

As an embodiment, the second communication device 410 corresponds to the second node in this application.

As an embodiment, the second communication device 410 corresponds to the third node in this application.

As an embodiment, the first communication device 450 is a UE.

As an embodiment, the first communication device 450 is a terminal.

As an embodiment, the first communication device 450 is a relay.

As an embodiment, the first communication device 450 is a terminal with positioning capability.

As an embodiment, the second communication device 410 is a UE.

As an embodiment, the second communication device 410 is a terminal.

As an embodiment, the second communication device 410 is a relay.

As an embodiment, the second communication device 410 is a terminal with positioning capability.

As an embodiment, the second communication device 410 is a base station.

As an embodiment, the second communication device 410 is a relay.

As an embodiment, the second communication device 410 is a network device.

As an embodiment, the second communication device 410 is a serving cell.

As an embodiment, the second communication device 410 is a TRP.

As an embodiment, the second communication device 410 is a base station with positioning capability.

As an embodiment, the second communication device 410 is a LMF.

As an embodiment, the second communication device 410 is a location service center.

As an embodiment, at least the first four of the antenna 452, the receiver 454, the multi-antenna receiving processor 458, the receiving processor 456, and the controller/processor 459 are used to receive a first set of information blocks; and at least the first four of the antenna 420, the transmitter 418, the multi-antenna transmitting processor 471, the transmitting processor 416, and the controller/processor 475 are used to send a first set of information blocks.

As an embodiment, at least the first four of the antenna 452, the receiver 454, the multi-antenna receive processor 458, the receive processor 456, and the controller/processor 459 are used to receive a first reference signal via a side link; and at least the first four of the antenna 420, the transmitter 418, the multi-antenna transmit processor 471, the transmit processor 416, and the controller/processor 475 are used to send a first reference signal via a side link.

As an embodiment, at least the first four of the antenna 452, the receiver 454, the multi-antenna receive processor 458, the receive processor 456, and the controller/processor 459 are used to receive a second reference signal via a downlink; and at least the first four of the antenna 420, the transmitter 418, the multi-antenna transmit processor 471, the transmit processor 416, and the controller/processor 475 are used to send a second reference signal via a downlink.

As an implementation, at least the first four of the antenna 452, the transmitter 454, the multi-antenna transmit processor 457, the transmit processor 468, and the controller/processor 459 are used to send first position information; and at least the first four of the antenna 420, the receiver 418, the multi-antenna receive processor 472, the receive processor 470, and the controller/processor 475 are used to receive the first position information.

As an implementation, at least the first four of the antenna 452, the transmitter 454, the multi-antenna transmit processor 457, the transmit processor 468, and the controller/processor 459 are used to send a third reference signal; and at least the first four of the antenna 420, the receiver 418, the multi-antenna receive processor 472, the receive processor 470, and the controller/processor 475 are used to receive a third reference signal.

### Example 5

Embodiment 5 illustrates a structural diagram of UE positioning according to an embodiment of the present application, as shown in FIG. 5.

UE 501 uses LTE (Long Term Evolution, Long Term Evolution)—Uu interface or NR (New The Uu new radio interface communicates with the ng-eNB502 or gNB503; ng-eNB502 and gNB503 are sometimes referred to as base stations, and ng-eNB502 and gNB503 are also referred to as NG (Next Next Generation)-RAN (Radio Access Network, wireless access network). ng-e NB502 and gNB 503 are respectively connected through NG (Next The next generation (next generation)-C (Control plane) is connected to the AMF (Authentication Management Field) 504; the AMF 504 is connected to the LMF (Location Management Function, location management function) 505 connection.

504 receives a location service request associated with a specific UE from another entity, such as a GMLC (Gateway Mobile Location Centre) or a UE, or the AMF 504 decides to start a location service associated with a specific UE; then the AMF 504 sends the location service request to a LMF, such as the LMF 505; then the LMF processes the location service request, including sending auxiliary data to the specific UE to assist UE-based or UE-assisted positioning, and including receiving location information (Location Information) reported by the UE. information); then the LMF returns the result of the location service to the AMF 504; if the location service is requested by another entity, the AMF 504 returns the result of the location service to that entity.

As an embodiment, the network device of the present application includes LMF.

As an embodiment, the network equipment of the present application includes NG-RAN and LMF.

As an embodiment, the network equipment of the present application includes NG-RAN, AMF and LMF.

### Example 6

Embodiment 6 illustrates a transmission flow chart between the first node, the second node and the third node of an embodiment, as shown in FIG. 6. In FIG. 6, the first node U1, the second node U2 and the third node N3 communicate with each other through a wireless link. It is particularly noted that the order in this embodiment does not limit the signal transmission order and the implementation order in this application. In the absence of conflict, the embodiments, sub-embodiments and subsidiary embodiments in Embodiment 6 can be applied to the embodiments, sub-embodiments and subsidiary embodiments in Embodiments 7 and 8 of this application; conversely, in the absence of conflict, the embodiments, sub-embodiments and subsidiary embodiments in Embodiments 7 and 8 of this application can be applied to Embodiment 6.

For the first node U1, a first information block set is received in step S10; a second reference signal is received in step S11; a first reference signal is received in step S12; and first location information is sent in step S13.

For the second node U2, a first reference signal is sent in step S20.

For the third node N3, in step S30, a first information block set is sent; in step S31, a second reference signal is sent; and in step S32, first location information is received.

Example 6, the first reference signal is transmitted via a sublink, and the second reference signal is transmitted via a downlink; the first information block set is used to determine the second reference signal; and the reception of the first reference signal and the reception of the second reference signal are jointly used to determine the first position information.

Typically, the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

As an embodiment, the first reference signal resource set corresponds to a Sidelink PRS Set.

As an embodiment, the first reference signal resource set corresponds to a Sidelink SRS Set.

As an embodiment, the first reference signal resource set corresponds to a Sidelink CSI-RS Set.

As an embodiment, the first reference signal resource set includes K1 first-category reference signal resources, the first reference signal resource set is one of the K1 first-category reference signal resources, and K1 is a positive integer greater than 1.

As a sub-embodiment of this embodiment, the K1 first-type reference signal resources correspond to K1 Sidelink PRS resources.

As a sub-embodiment of this embodiment, the K1 first-type reference signal resources correspond to K1 Sidelink SRS resources.

As a sub-embodiment of this embodiment, the K1 first-type reference signal resources correspond to K1 Sidelink CSI-RS resources.

As an embodiment, the second reference signal resource set corresponds to a DL PRS

### Set.

As an embodiment, the second reference signal resource set corresponds to a DL CSI-RS Set.

As an embodiment, the second reference signal resource set corresponds to an SSB Set.

As an embodiment, the second reference signal resource set includes K2 second-type reference signal resources, the second reference signal resource set is one of the K2 second-type reference signal resources, and K2 is a positive integer greater than 1.

As a sub-embodiment of this embodiment, the 2 second-type reference signal resources correspond to K2 DL PRS resources.

As a sub-embodiment of this embodiment, the K2 second-type reference signal resources correspond to K2 DL CSI-RS resources.

As a sub-embodiment of this embodiment, the K2 second-type reference signal resources correspond to K2 SSBs respectively.

As an embodiment, the first information block set is used to determine that the first reference signal set and the second reference signal set are associated, which means that the first information block set includes configuration information of the first reference signal set, and the configuration information of the first reference signal set includes the identity corresponding to the second reference signal set.

As an embodiment, the first information block set is used to determine that the first reference signal set and the second reference signal set are associated, which means that the first information block set includes configuration information of the second reference signal set, and the configuration information of the second reference signal set includes the identity corresponding to the first reference signal set.

As an embodiment, the first information block set is used to determine that the first reference signal set and the second reference signal set are associated, which means that the first reference signal set and the second reference signal set are associated with the same identity.

As an embodiment, the meaning that the first information block set is used to determine that the first reference signal set and the second reference signal set are associated includes: the first information block set is used to indicate that the first reference signal set and the second reference signal set are associated to the same QCL relationship.

As a sub-embodiment of this embodiment, the QCL relationship includes TCI-StateId.

Typically, the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

As an embodiment, the first reference signal resource set includes a Sidelink PRS resource pool.

As an embodiment, the K1 first-type reference signals correspond to K1 sidelinks respectively. PRS.

As an embodiment, the K1 first-type reference signals correspond to K1 sidelinks respectively. SRS.

As an embodiment, the K1 first-type reference signals correspond to K1 sidelinks respectively. CSI-RS.

As an embodiment, the first information block set is used to determine that the transmission timings of the K1 first-type reference signals are the same, which means that the first information block set is used to indicate that the transmission timings of the K1 first-type reference signals are the same.

As an embodiment, the first information block set is used to determine that the transmission timing of the K1 first-type reference signals is the same, which means that the first information block set is used to indicate a first identity, the first reference signal resource set is associated with the first identity, and the first identity is used for timing advance.

As an embodiment, the first information block set is used to determine that the transmission timings of the K1 first-type reference signals are the same, which means that the first information block set is used to determine that the transmission of the K1 first-type reference signals adopts the same timing advance value.

As an embodiment, the first information block set is used to determine that the transmission timings of the K1 first-type reference signals are the same, which means that the first information block set is used to determine that the K1 first-type reference signals correspond to the same QCL relationship.

Typically, the same transmission timing of the K1 first-type reference signals means that: the K1 first-type reference signals are transmitted using the same timing advance value.

As an embodiment, the sending timings of the K1 first-type reference signals all refer to the same receiving timing.

As an embodiment, the sending timings of the K1 first-type reference signals all refer to the receiving timing of the second reference signal.

As an embodiment, the reception timing of the second reference signal is used to determine the transmission timing of any first-type reference signal among the K1 first-type reference signals.

As an embodiment, the reception timing of any second-type reference signal among the K2 second-type reference signals is used to determine the transmission timing of any first-type reference signal among the K1 first-type reference signals.

Typically, the second node and the third node are not co-located.

As an embodiment, the sender of the first reference signal is the second node, and the sender of the second reference signal is the third node.

As an embodiment, the non-co-location means: being located in different geographical locations.

As an embodiment, the meaning of non-co-location includes: different nodes.

As an embodiment, the non-co-location means that there is no wired link between them.

As an embodiment, the meaning of non-co-location includes: being different devices.

As an embodiment, the second node is a terminal.

As an embodiment, the second node is an RSU.

As an embodiment, the first node is a base station.

As an embodiment, the first node is a gNB.

Typically, the time difference between the reception time of the second reference signal and the transmission time of the first reference signal is known to the first node.

As an embodiment, the time difference between the receiving time when the second node receives the second reference signal and the sending time when the second node sends the first reference signal is a third time difference, the receiving time of the second reference signal corresponds to the starting time of the time slot in which the second reference signal is received, the sending time of the first reference signal corresponds to the starting time of the time slot in which the second reference signal is sent, and the third time difference is equal to the time slot interval between the time slot in which the second reference signal is received and the time slot in which the second reference signal is sent.

As an embodiment, the time difference between the reception time of the second reference signal and the transmission time of the first reference signal is fixed.

As an embodiment, the time difference between the reception time of the second reference signal and the transmission time of the first reference signal is predefined.

### Example 7

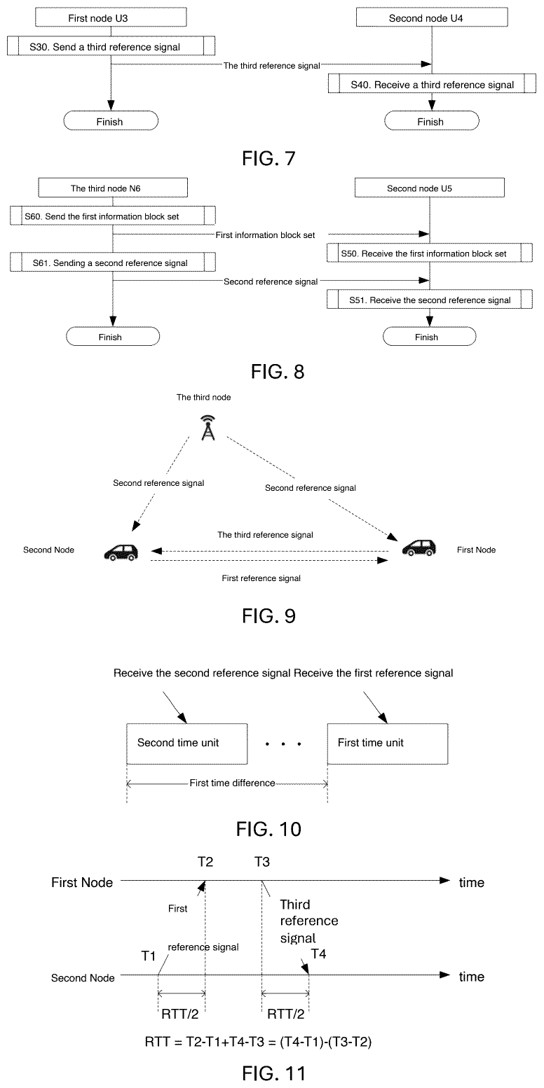

Embodiment 7 illustrates a transmission flow chart of the first node and the second node of an embodiment, as shown in FIG. 7. In FIG. 7, the first node U3 communicates with the second node U4 via a wireless link. It is particularly noted that the order in this embodiment does not limit the signal transmission order and implementation order in this application. In the absence of conflict, the embodiments, sub-embodiments and subsidiary embodiments in Embodiment 7 can be applied to the embodiments, sub-embodiments and subsidiary embodiments in Embodiments 6 and 8 of this application; conversely, in the absence of conflict, the embodiments, sub-embodiments and subsidiary embodiments in Embodiments 6 and 8 of this application can be applied to Embodiment 7.

For the first node U3, a third reference signal is sent in step S30.

For the second node U4, a third reference signal is received in step S40.

In Embodiment 7, the reception timing of the second reference signal is used to determine the transmission timing of the third reference signal.

As an embodiment, the third reference signal includes Sidelink PRS.

As an embodiment, the third reference signal includes Sidelink SRS.

As an embodiment, the third reference signal includes Sidelink CSI-RS.

As an embodiment, the third reference signal occupies a Sidelink PRS resources.

As an embodiment, the third reference signal occupies a Sidelink SRS resources.

As an embodiment, the third reference signal occupies a Sidelink CSI-RS resources.

As an embodiment, the third reference signal corresponds to a Sidelink PRS resources.

As an embodiment, the third reference signal corresponds to a Sidelink SRS resources.

As an embodiment, the third reference signal corresponds to a Sidelink CSI-RS resources.

As an embodiment, the above phrase “the reception timing of the second reference signal is used to determine the transmission timing of the third reference signal” means that the reception timing of the second reference signal corresponds to the downlink timing of the first node, and the transmission timing of the third reference signal corresponds to the uplink timing of the first node.

As an embodiment, the above phrase “the reception timing of the second reference signal is used to determine the transmission timing of the third reference signal” means that the reception timing of the second reference signal is used to determine the downlink timing of the first node, and the downlink timing of the first node is used to determine the transmission timing of the third reference signal.

As an embodiment, the third reference signal is located in the i-th uplink frame of the first node, and the start (Start) of the i-th uplink frame is TTA earlier than the start of the i-th downlink frame of the first node, and the TTA corresponds to the timing advance of the first node when sending to the third node in this application.

Typically, the second node sends second location information, and the first reference signal and the third reference signal are used together to determine the second location information.

As an embodiment, the second location information includes a fourth time difference, and the fourth time difference is the time difference between the time when the second node receives the third reference signal and the time when it sends the first reference signal.

As an embodiment, step S30 is located after step S12 and before step S13 in embodiment 5.

As an embodiment, step S40 is located after step S20 in embodiment 5.

### Example 8

Embodiment 8 illustrates a transmission flow chart of the second node and the third node of an embodiment, as shown in FIG. 8. In FIG. 8, the second node U5 communicates with the third node N6 via a wireless link. It is particularly noted that the order in this embodiment does not limit the signal transmission order and implementation order in this application. In the absence of conflict, the embodiments, sub-embodiments and subsidiary embodiments in Embodiment 8 can be applied to the embodiments, sub-embodiments and subsidiary embodiments in Embodiments 6 and 7 of this application; conversely, in the absence of conflict, the embodiments, sub-embodiments and subsidiary embodiments in Embodiments 6 and 7 of this application can be applied to Embodiment 8.

For the second node U5, a first information block set is received in step S50; and a second reference signal is received in step S51.

For the third node N6, a first information block set is sent in step S60; and a second reference signal is sent in step S61.

As an embodiment, step S50 is located before step S20 in embodiment 5.

As an embodiment, step S50 is located after step S20 in embodiment 5.

As an embodiment, step S51 is located before step S20 in embodiment 5.

As an embodiment, step S51 is located after step S20 in embodiment 5.

As an embodiment, step S60 is the same as step S30 in embodiment 5.

As an embodiment, step S61 is the same as step S31 in embodiment 5.

### Example 9

Embodiment 9 illustrates a schematic diagram between a first node, a second node, and a third node according to an embodiment of the present application, as shown in FIG. 9. In FIG. 9, the third node and the second node both participate in determining the positioning of the first node; the third node sends a second reference signal, and the first node and the second node both receive the second reference signal; the second node sends a first reference signal, and the first node receives the first reference signal; the first node sends a third reference signal, and the second node receives the third reference signal.

As an embodiment, the first information block set is used to configure the second reference signal.

As an embodiment, the first information block set is used to configure the first reference signal.

As an embodiment, the first information block set is used to configure the third reference signal.

As an embodiment, the first information block set is used to determine the second reference signal.

As an embodiment, the first information block set is used to determine the first reference signal.

As an embodiment, the first information block set is used to determine the third reference signal.

As an embodiment, the third node sends K2 second-type reference signals, and the second reference signal is one of the K2 second-type reference signals.

As an embodiment, the second node sends K1 first-type reference signals, and the first reference signal is one of the K1 first-type reference signals.

### Example 10

Embodiment 10 illustrates a schematic diagram of a first time difference according to an embodiment of the present application, as shown in FIG. 10. In FIG. 10, the first time difference is the time difference between the time when the first node receives the first reference signal and the time when the second reference signal is received. The first time unit shown in the figure corresponds to the time unit where the received first reference signal is located, and the second time unit shown in the figure corresponds to the time unit where the received second reference signal is located; the time difference between the start time of the first time unit and the start time of the second time unit is the first time difference.

As an embodiment, the first time unit and the second time unit are both a subframe.

As an embodiment, the first time unit and the second time unit are both a time slot.

As an embodiment, the first time unit and the second time unit are both a frame.

As an embodiment, the first time unit is one or more consecutive OFDM symbols.

As an embodiment, the second time unit is one or more consecutive OFDM symbols.

As an embodiment, the unit of the first time difference is seconds.

As an embodiment, the unit of the first time difference is milliseconds.

As an embodiment, the unit of the first time difference is microseconds.

### Embodiment 11

Embodiment 11 illustrates a schematic diagram of a second time difference and a fourth time difference according to an embodiment of the present application, as shown in FIG. 11. In FIG. 11, the second time difference is the time difference between the time when the first node receives the first reference signal and the time when the third reference signal is sent, and the fourth time difference is the time difference between the time when the third node receives the third reference signal and the time when the first reference signal is sent; T1 in the figure corresponds to the time when the second node sends the first reference signal, T2 in the figure corresponds to the time when the first node receives the first reference signal, T3 in the figure corresponds to the time when the first node sends the third reference signal, and T4 in the figure corresponds to the time when the second node receives the third reference signal; it can be seen from the figure that the RTT (Round Trip Time) between the first node and the second node is equal to (T4−T1) minus (T3−T2), and half of the RTT value corresponds to the transmission delay from the second node to the first node, and then the value of RTT/2 can be used to obtain the distance from the second node to the first node; the difference between T4 and T1 in the figure corresponds to the fourth time difference, and the difference between T3 and T2 in the figure corresponds to the second time difference.

As an embodiment, T1 corresponds to the starting time of the time slot occupied by sending the first reference signal.

As an embodiment, T1 corresponds to the starting time of the subframe occupied by sending the first reference signal.

As an embodiment, T1 corresponds to the starting time of the frame occupied by sending the first reference signal.

As an embodiment, T1 corresponds to the starting time of sending one or more OFDM symbols occupied by the first reference signal.

As an embodiment, T2 corresponds to the starting time of the time slot occupied by the received first reference signal.

As an embodiment, T2 corresponds to the starting time of the subframe occupied by the received first reference signal.

As an embodiment, T2 corresponds to the starting time of the frame occupied by the first received reference signal.

As an embodiment, T2 corresponds to the starting time of one or more OFDM symbols occupied by the received first reference signal.

As an embodiment, T3 corresponds to the starting time of the time slot occupied by sending the third reference signal.

As an embodiment, T3 corresponds to the starting time of the subframe occupied by sending the third reference signal.

As an embodiment, T3 corresponds to the starting time of the frame occupied by sending the third reference signal.

As an embodiment, T3 corresponds to the starting time of sending one or more OFDM symbols occupied by the third reference signal.

As an embodiment, T4 corresponds to the starting time of the time slot occupied by the received third reference signal.

As an embodiment, T4 corresponds to the starting time of the subframe occupied by the received third reference signal.

As an embodiment, T4 corresponds to the starting time of the frame occupied by the received third reference signal.

As an embodiment, T4 corresponds to the starting time of one or more OFDM symbols occupied by the received third reference signal.

As an embodiment, the unit of the second time difference is seconds.

As an embodiment, the unit of the second time difference is milliseconds.

As an embodiment, the unit of the second time difference is microseconds.

As an embodiment, the unit of the fourth time difference is seconds.

As an embodiment, the unit of the fourth time difference is milliseconds.

As an embodiment, the unit of the fourth time difference is microseconds.

### Example 12

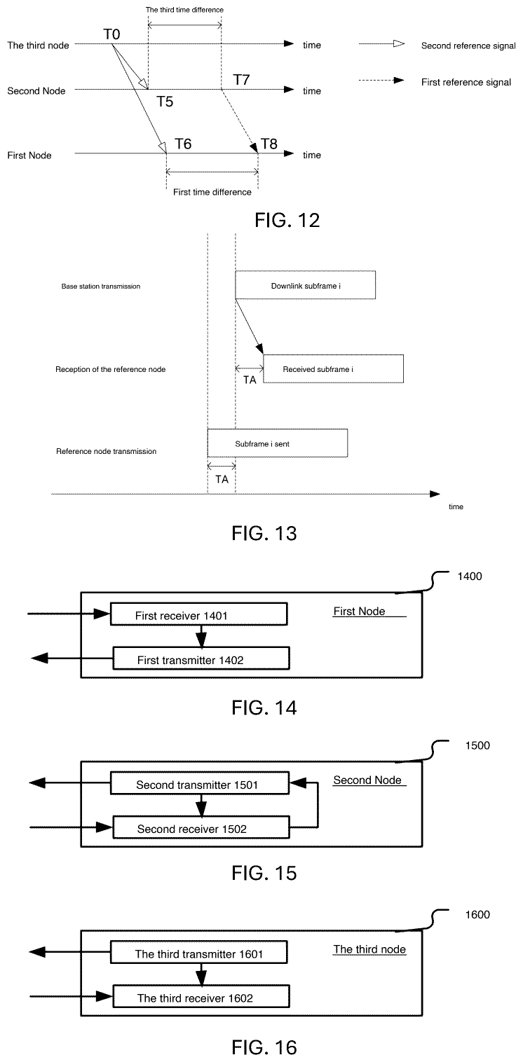

Embodiment 12 illustrates a schematic diagram of a third time difference according to an embodiment of the present application, as shown in FIG. 12. In FIG. 12, the time difference between the time when the second node receives the second reference signal and the time when the second node sends the first reference signal is the third time difference; the second node and the third node can communicate with each other through DL The PRS obtains the distance between the second node and the third node. The first node and the third node can be connected through DL PRS obtains the distance of the first node relative to the third node; the distance from the third node to the second node and then to the first node shown in the figure corresponds to the first path distance, and the distance from the third node directly to the first node shown in the figure corresponds to the second path distance; then the value of the first time difference minus the third time difference in this application can infer the difference between the first path distance and the second path distance, which is then used for the positioning of the first node.

As an embodiment, the positioning of the first node is the positioning of the first node compared to the second node.

As an embodiment, the value of the first time difference minus the third time difference in the present application can infer the difference between the first path distance and the second path distance.

As an embodiment, the third time difference is equal to (T7-T5) in the figure.

As an embodiment, the first time difference is equal to (T8-T6) in the figure.

As an embodiment, the value of (T5-TO) in the figure is determined by the positioning between the first node and the third node.

As an embodiment, the value of (T6−T0) in the figure is determined by the positioning between the second node and the third node.

As an embodiment, the value of (T8−T7) in the figure corresponds to the positioning information between the first node and the second node, and the value of (T8−T7) is obtained by subtracting the third time difference from the first time difference and adding (T6−T5), and the (T6−T5) is obtained by the positioning between the first node and the third node, and the positioning between the second node and the third node.

### Example 13

Embodiment 13 illustrates a schematic diagram of the transmission timing of a given reference signal according to an embodiment of the present application, as shown in FIG. 13. In FIG. 13, the transmission timing of the given reference signal is determined by the uplink timing of the base station corresponding to the serving cell of the given node, that is, the given reference signal is transmitted one TA in advance to ensure that no interference is caused to the uplink of the base station.

As an embodiment, the given reference signal corresponds to the first reference signal in this application.

As an embodiment, the given reference signal corresponds to the third reference signal in the present application.

As an embodiment, the given node corresponds to the first node in the present application.

As an embodiment, the given node corresponds to the second node in the present application.

As an embodiment, the downlink timing of the serving cell is used to determine the sending timing of the given reference signal.

As an embodiment, the TA shown in the figure is equal to RTT/2 between the given node and the base station.

### Embodiment 14

Embodiment 14 illustrates a structural block diagram of a first node, as shown in FIG. 14. In FIG. 14, the first node 1400 includes a first receiver 1401 and a first transmitter 1402.

A first receiver 1401 receives a first information block set, receives a first reference signal via a side link, and receives a second reference signal via a downlink; A first transmitter 1402 sends first location information;

Embodiment 14, the first information block set is used to determine the second reference signal; and the reception of the first reference signal and the reception of the second reference signal are used together to determine the first position information.

As an embodiment, it includes:
The first transmitter 1402 sends a third reference signal;
The reception timing of the second reference signal is used to determine the transmission timing of the third reference signal.

As an embodiment, the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

As an embodiment, the first reference signal resource belongs to a first reference signal resource set, the first reference signal resource set includes K1 first-class reference signal resources, the K1 first-class reference signal resources are respectively occupied by K1 first-class reference signals, and the first reference signal is one of the K1 first-class reference signals; the first information block set is used to determine that the sending timing of the K1 first-class reference signals is the same.

As an embodiment, the meaning that the sending timings of the K1 first-type reference signals are the same includes: the K1 first-type reference signals are sent using the same timing advance value.

As an embodiment, the sender of the first reference signal and the sender of the second reference signal are not co-located.

As an embodiment, the sender of the first reference signal includes a second node, the second node receives the second reference signal, and the time difference between the reception time of the second reference signal and the transmission time of the first reference signal is known to the first node.

As an embodiment, the first information block set is used to determine whether the first reference signal and the second reference signal are associated.

As an embodiment, the first receiver 1401 includes at least the first four of the antenna 452, the receiver 454, the multi-antenna receiving processor 458, the receiving processor 456, and the controller/processor 459 in Embodiment 4.

As an embodiment, the first transmitter 1402 includes at least the first four of the antenna 452, transmitter 454, multi-antenna transmit processor 457, transmit processor 468, and controller/processor 459 in Embodiment 4.

### Embodiment 15

Embodiment 15 illustrates a structural block diagram of a second node, as shown in FIG. 15. In FIG. 15, the second node 1500 includes a second transmitter 1501.

A second transmitter 1501 sends a first reference signal via a secondary link;

In Example 15, the recipient of the first reference signal includes a first node; the first node receives a first information block set and receives a second reference signal via a downlink; the first information block set is used to determine the second reference signal; the reception of the first reference signal and the reception of the second reference signal are jointly used to determine first location information; the first node sends the first location information.

As an embodiment, it includes:
receiver 1502 receives a first information block set and a second reference signal via a downlink;
The first information block set is used to determine the second reference signal.

As an embodiment, it includes:

The second receiver 1 502 receives first location information.

As an embodiment, it includes:
The second receiver 1 502 receives a third reference signal;
The reception timing of the second reference signal is used by the first node to determine the transmission timing of the third reference signal.

As an embodiment, the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

As an embodiment, the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

As an embodiment, the meaning that the sending timings of the K1 first-type reference signals are the same includes: the K1 first-type reference signals are sent using the same timing advance value.

As an embodiment, the second node and the sender of the second reference signal are not co-located.

As an embodiment, the time difference between the reception time of the second reference signal and the transmission time of the first reference signal is known to the first node.

As an embodiment, the first information block set is used to determine whether the first reference signal and the second reference signal are associated.

embodiment, the second transmitter 1501 includes at least the first four of the antenna 420, transmitter 418, multi-antenna transmit processor 471, transmit processor 416, and controller/processor 475 in Embodiment 4.

As an embodiment, the second receiver 150 2 includes at least the first four of the antenna 420, the receiver 418, the multi-antenna receiving processor 472, the receiving processor 470, and the controller/processor 475 in Embodiment 4.

### Example 16

Embodiment 16 illustrates a structural block diagram in a third node, as shown in FIG. 16. In FIG. 16, the third node 1600 includes a third transmitter 1601.

transmitter 1601 sends a first information block set and a second reference signal via a downlink;

In embodiment 16, the receiver of the second reference signal includes a first node; the first node receives the first reference signal through a sub-link, and the first node sends first position information; the first information block set is used to determine the second reference signal; the reception of the first reference signal and the reception of the second reference signal are jointly used to determine the first position information.

As an embodiment, it includes:

receiver 1602 receives the first location information.

As an embodiment, the first node sends a third reference signal; the reception timing of the second reference signal is used to determine the transmission timing of the third reference signal.

As an embodiment, the first reference signal occupies a first reference signal resource, and the first reference signal resource belongs to a first reference signal resource set; the second reference signal occupies a second reference signal resource, and the second reference signal resource belongs to a second reference signal resource set; the first information block set is used to determine that the first reference signal set and the second reference signal set are associated.

As an embodiment, the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; the first information block set is used to determine that the sending timing of the K1 first-type reference signals is the same.

As an embodiment, the meaning that the sending timings of the K1 first-type reference signals are the same includes: the K1 first-type reference signals are sent using the same timing advance value.

As an embodiment, the sender of the first reference signal and the third node are not co-located.

As an embodiment, the sender of the first reference signal includes a second node, the second node receives the second reference signal, and the time difference between the reception time of the second reference signal and the transmission time of the first reference signal is known to the first node.

As an embodiment, the first information block set is used to determine whether the first reference signal and the second reference signal are associated.

As an embodiment, the third transmitter 1601 includes at least the first four of the antenna 420, the transmitter 418, the multi-antenna transmit processor 471, the transmit processor 416, and the controller/processor 475 in Embodiment 4.

As an embodiment, the third receiver 1602 includes at least the first four of the antenna 420, the receiver 418, the multi-antenna receiving processor 472, the receiving processor 470, and the controller/processor 475 in Embodiment 4.

A person of ordinary skill in the art can understand that all or part of the steps in the above method can be completed by instructing the relevant hardware through a program, and the program can be stored in a computer-readable storage medium, such as a read-only memory, a hard disk or an optical disk. Optionally, all or part of the steps in the above embodiment can also be implemented using one or more integrated circuits. Accordingly, each module unit in the above embodiment can be implemented in the form of hardware or in the form of a software function module, and the present application is not limited to any specific form of software and hardware combination. The first node in the present application includes but is not limited to mobile phones, tablet computers, notebooks, Internet cards, low-power devices, eMTC devices, NB-IoT devices, vehicle-mounted communication equipment, transportation tools, vehicles, RSUs, aircraft, airplanes, drones, remote-controlled aircraft and other wireless communication devices. The second node in the present application includes but is not limited to macrocell base stations, microcell base stations, small cell base stations, home base stations, relay base stations, eNBs, gNBs, transmission and reception nodes TRPs, GNSSs, relay satellites, satellite base stations, air base stations, RSUs, drones, test equipment, such as transceivers or signaling testers that simulate some functions of base stations, and other wireless communication devices.

It should be understood by those skilled in the art that the present invention may be implemented in other specified forms without departing from its core or essential features. Therefore, the embodiments disclosed herein should be considered illustrative rather than restrictive in any way. The scope of the invention is determined by the appended claims rather than the preceding description, and all modifications within their equivalent meanings and regions are considered to be included therein.

1. A first node for wireless communication, comprising:
a first receiver, configured to receive a first information block set, receive a first reference signal through a sidelink, and receive a second reference signal through a downlink; and
a first transmitter, configured to send first position information;
wherein the first information block set is used to determine the second reference signal; and reception of the first reference signal and reception of the second reference signal are jointly used to determine the first position information.

2. The first node according to claim 1, wherein:
the first transmitter is further configured to transmit a third reference signal; and
a receiving timing of the second reference signal is used to determine a sending timing of the third reference signal.

3. The first node according to claim 1 or 2, wherein;
the first reference signal occupies a first reference signal resource, and the first reference signal resource belongs to a first reference signal resource set;
the second reference signal occupies a second reference signal resource, and the second reference signal resource belongs to a second reference signal resource set; and
the first information block set is used to determine that the first reference signal set and the second reference signal set are associated.

4. The first node according to claim 3, wherein;
the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; and
the first information block set is used to determine that transmission timing of the K1 first-type reference signals is the same.

5. The first node according to claim 4, wherein determining transmission timing of the K1 first-type reference signals is the same comprises determining the K1 first-type reference signals are sent by using a same timing advance value.

6. The first node according to claim 5, wherein a sender of the first reference signal and a sender of the second reference signal are non-co-located.

7. The first node according to claim 6, wherein a sender of the first reference signal comprises a second node, the second node receives the second reference signal, and a time difference between a receiving moment of the second reference signal and a sending moment of the first reference signal is known to the first node.

8. The first node according to claim 7, wherein the first information block set is used to determine that the first reference signal and the second reference signal are associated.

9-27. (canceled)

28. A method in a first node for wireless communication, comprising:
receiving a first information block set, receiving a first reference signal through a sidelink, and receiving a second reference signal through a downlink; and
sending first location information;
wherein the first information block set is used to determine the second reference signal;
and reception of the first reference signal and reception of the second reference signal are jointly used to determine the first position information.

29. The method according to claim 28, comprising:
sending a third reference signal;
wherein a receiving timing of the second reference signal is used to determine a sending timing of the third reference signal.

30. The method according to claim 29, wherein:
the first reference signal occupies a first reference signal resource, and the first reference signal resource belongs to a first reference signal resource set;
the second reference signal occupies a second reference signal resource, and the second reference signal resource belongs to a second reference signal resource set; and
the first information block set is used to determine that the first reference signal set and the second reference signal set are associated.

31. The method according to claim 30, wherein;
the first reference signal resource belongs to a first reference signal resource set, the first reference signal resource set includes K1 first-type reference signal resources, the K1 first-type reference signal resources are respectively occupied by K1 first-type reference signals, and the first reference signal is one of the K1 first-type reference signals; and
the first information block set is used to determine that transmission timing of the K1 first-type reference signals is the same.

32. The method according to claim 31, wherein determining sending timings of the K1 first-type reference signals are the same comprises determining the K1 first-type reference signals are sent by using a same timing advance value.

33. The method according to claim 32, wherein the sender of the first reference signal and the sender of the second reference signal are non-co-located.

34. The method according to claim 33, wherein a sender of the first reference signal comprises a second node, the second node receives the second reference signal, and a time difference between a receiving moment of the second reference signal and a sending moment of the first reference signal is known to the first node.

35. The method according to claim 34, wherein the first information block set is used to determine that the first reference signal and the second reference signal are associated.

36-54. (canceled)
